(19) United States
(12) Patent Application Publication
(10) Pub. No.: US 2026/0148345 A1
(43) Pub. Date: May 28, 2026

(54) ACCELERATING DIFFUSION MODEL SAMPLING USING SECOND ORDER TIME TRAJECTORY

(71) Applicant: ADOBE INC., SAN JOSE, CA (US)

(72) Inventors: Tarun Kathuria, San Mateo, CA (US); Anup Bandigadi Rao, San Jose, CA (US); Difan Liu, San Jose, CA (US); Tung Mai, San Jose, CA (US); Raghavendra Kiran Addanki, Santa Clara, CA (US); David Arbour, Charlottesville, VA (US)

(21) Appl. No.: 18/957,170

(22) Filed: Nov. 22, 2024

(51) Int. Cl. G06T 5/60; G06T 5/70; G06T 11/00

(52) U.S. Cl. CPC G06T 5/60; G06T 5/70; G06T 11/00; G06T 2207/20081; G06T 2207/20084; G06T 2207/30241

(57) ABSTRACT

A method, apparatus, non-transitory computer readable medium, and system for performing an accelerated denoising process includes obtaining a noise map from a noise distribution. Embodiments then compute, using an image generation model, a denoising vector based on an accelerated denoising trajectory, where the accelerated denoising trajectory accelerates a denoising rate based on a diffusion timestep. Then, embodiments generate, using the image generation model, a synthetic image by denoising the noise map based on the denoising vector.

### BACKGROUND

The following relates generally to data processing, and more specifically to data generation, particularly image data generation. Image processing is a type of data processing that involves the manipulation of an image to get the desired output, typically utilizing specialized algorithms and techniques. Image processing techniques include operations on an image to enhance its quality or to extract useful information from it. This process usually comprises a series of steps that includes the importation of the image, its analysis, manipulation to enhance features or remove noise, and the eventual output of the enhanced image or salient information it contains.

Data generation is a type of data processing in which new data is created based on patterns found in existing datasets, often involving techniques to extrapolate or infer data to simulate realistic scenarios or complete missing information. This area includes the use of generative machine learning models, which are specifically designed to produce new data points, such as images, by learning from a corpus of examples. Denoising Diffusion Probabilistic Models (DDPMs) are a class of generative model that is capable of generating high-quality images through a process of gradually adding and then removing noise.

### SUMMARY

Embodiments of the inventive concepts described herein include systems and methods for performing an accelerated diffusion process using a second order time trajectory. Embodiments include an image generation model configured to implement a discretized second order time trajectory that iteratively denoises a sample. The second order time trajectory leverages Hamiltonian dynamics to optimize the path of the diffusion process and reduce the number of iterations performed in the generation of high-quality images. This approach allows for a more efficient generation of images by utilizing discretization techniques from optimization theory, such as Nesterov's accelerated gradient method. Embodiments thereby perform a generation process that follows a gradient flow trajectory in the measure space that is optimal in terms of entropy, ensuring that the generation process follows the most efficient path possible.

A method, apparatus, non-transitory computer readable medium, and system for data generation are described. One or more aspects of the method, apparatus, non-transitory computer readable medium, and system include obtaining a noise map; computing, using an image generation model, a denoising vector based on an accelerated denoising trajectory, wherein the accelerated denoising trajectory accelerates a denoising rate based on a diffusion timestep; and generating, using the image generation model, a synthetic image by denoising the noise map based on the denoising vector.

A method, apparatus, non-transitory computer readable medium, and system for data generation are described. One or more aspects of the method, apparatus, non-transitory computer readable medium, and system include identifying a diffusion step based on a scheduling function; computing a denoising vector based on the diffusion step and a second order differential equation representing an accelerated denoising trajectory; and generating a synthetic image by denoising a noise map based on the denoising vector.

An apparatus, system, and method for data generation are described. One or more aspects of the apparatus, system, and method include at least one processor; at least one memory storing instructions executable by the at least one processor; and an image generation model comprising parameters stored in the at least one memory and configured to compute a denoising vector based on a second order differential equation representing an accelerated denoising trajectory and to generate a synthetic image by denoising a noise map based on the denoising vector.

### BRIEF DESCRIPTION OF THE DRAWINGS

FIG. 1 shows an example of conventional path and updated path between distributions according to aspects of the present disclosure.

FIG. 2 shows an example of a data processing apparatus according to aspects of the present disclosure.

FIG. 3 shows an example of an image generation model according to aspects of the present disclosure.

FIG. 4 shows an example of a U-Net according to aspects of the present disclosure.

FIG. 5 shows an example of a method for conditional image generation according to aspects of the present disclosure.

FIG. 6 shows an example of a training algorithm according to aspects of the present disclosure.

FIG. 7 shows an example of a method a method for training a diffusion model according to aspects of the present disclosure.

FIG. 8 shows an example of a computing device according to aspects of the present disclosure.

FIG. 9 shows an example of a method for generating a synthetic image according to aspects of the present disclosure.

### DETAILED DESCRIPTION

Recently, users have incorporated generative machine learning (ML) models into their creative process, as these models have the capability to automatically generate novel content such as images, music, and text. Generative ML models function by learning from vast amounts of data to capture underlying patterns and distributions, enabling them to produce new examples that are indistinguishable from authentic data. Among the various classes of generative models, Generative Adversarial Networks (GANs) and Variational Autoencoders (VAEs) are particularly popular. GANs operate through a competitive process between two neural networks—a generator that creates images and a discriminator that evaluates them—enhancing the quality of generation over time. VAEs, on the other hand, optimize a probabilistic framework to encode and decode images.

More recently, attention has shifted towards Denoising Diffusion Probabilistic Models (DDPMs), a class of generative models that offer significant advancements in image quality and variability. DDPMs work by initially introducing noise to an image and then learning to reverse this process, effectively ‘denoising’ to generate new images. This process involves a gradual transformation from a random noise distribution back to the data distribution, guided by a learned diffusion process.

In addition to DDPMs, there is another class of diffusion models known as score-based models (SBMs). Both models are grounded in the framework of Stochastic Differential Equations (SDEs), where SBMs are associated with “Variance Exploding SDEs” and DDPMs with “Variance Preserving SDEs.” Although DDPMs are more widely recognized due to their robust theoretical underpinnings and simpler parameterization, SBMs offer a valid observation-based methodology to denoising that is also effective in applications such as image generation. SBMs focus on learning the “score,” or the gradient of the data's probability density, which informs the direction and magnitude needed to reconstruct or generate data from noise. This contrasts with DDPMs, which estimate noise directly during their reverse denoising process. In some aspects, the forward process in SBMs involves straightforward noise addition, whereas in DDPMs, noise addition is coupled with a controlled attenuation of the signal. This attenuation is closely linked to a predetermined noise schedule, denoted by βt, which shapes the reverse diffusion process, making it subtly distinct from that of SBMs.

There are some approaches to accelerating diffusion models that are based on re-forming the SDE as a second order time trajectory coupled to a momentum variable. For example, one such approach is given by Equation (1):

$$\frac{{dX}_{t}}{dt} = {P}_{t} , and \frac{{dP}_{t}}{dt} = \frac{{X}_{t}}{2} - \frac{{v}_{t} ( {X}_{t} , {P}_{t} )}{2} , \qquad ( 1 )$$

$$where {v}_{t} ( {X}_{t} ) = ∇ {lnQ}_{1 - t} f ( {X}_{t} , {P}_{t} )$$

where Xₜ is the current sample at time t, Q is a is a time varying expectation operator, and vₜ(Xₜ) is the score function, and is parameterized by variable P which is a momentum variable that is related to a momentum in the Hamiltonian interpretation of the equation, and coupled to Xₜ. While this approach can yield speed increases in some domains, it necessitates a total retrain of the diffusion model due to the integrated dependence on the momentum variable Pₜ which affects the training dynamics and the model's stability.

Embodiments of the present disclosure improve on accelerated diffusion models by implementing a denoising trajectory in second order time that does not necessitate retraining pre-trained diffusion models. Embodiments compute an updated second order time trajectory for denoising, that is decoupled from the P momentum variable. This new model configuration enhances the efficiency of the diffusion process without relying on the momentum variable, thereby simplifying the model training and potentially reducing the need for frequent retraining. An example of the updated relationship is given by Equation (2):

$$\frac{d}{dt} ( {X}_{t} + \frac{{e}^{- {α}_{t}} {dX}_{t}}{dt} ) = \frac{{X}_{t}}{2} - \frac{{v}_{t} ( {X}_{t} )}{2} , \qquad ( 2 )$$

$$where {e}^{- {α}_{t}} is an attenuation term$$

The score function vₜ is based solely on image variable Xₜ and leverages the inherent properties of the original denoising function, which is a gradient of a distance function in the space of probability measures. In this way, the updated trajectory maintains the ability to generate high-quality images. This decoupling allows the denoising function to independently adjust to the image details at each step, ensuring that the essential characteristics needed to produce a high-quality output are inherently preserved, even as the process is accelerated. This equation exploits a previously unknown gradient optimality property of the score function in diffusion models, enabling a second order acceleration based on the computed score function. According to some aspects, this continuous second order time trajectory can then be discretized for computation by adopting Nesterov style discretization or collocation-based methods or symplectic integrators. It naturally follows that a faster trajectory in continuous time leads to a faster trajectory in discrete time, thereby enabling an image generation model to generate synthetic images with fewer forward pass evaluations and increased speed.

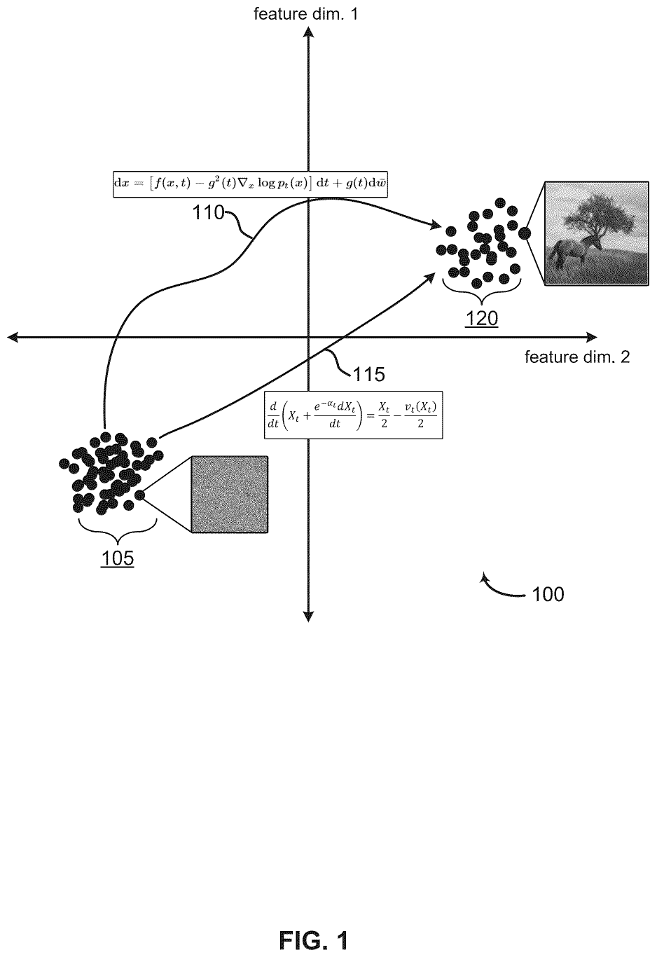

FIG. 1 shows an example of conventional path and updated path between distributions according to aspects of the present disclosure. The example shown includes two-axis space 100, noise distribution 105, first order trajectory 110, second order trajectory 115, and image data distribution 120.

The two-axis space 100 is a simplification of a feature space to help illustrate the concept of finding a trajectory in the feature space of a diffusion model that paths between noise distribution 105 and image data distribution 120. According to some aspects, the first order trajectory 110 is not an optimal path through the space, and a greater “distance” is traveled to reach the image data distribution 120, which contains the desired samples for generation (e.g., photorealistic images). According to some aspects, the first order trajectory 110 is represented by the equation adjacent to its path in the Figure. In contrast, the second order trajectory 115 is a shorter path between the two distributions, corresponding to more computationally efficient and faster image generation. According to some aspects, the second order trajectory 115 is represented by the equation adjacent to its path in the Figure. This Equation is recited above as Equation (2).

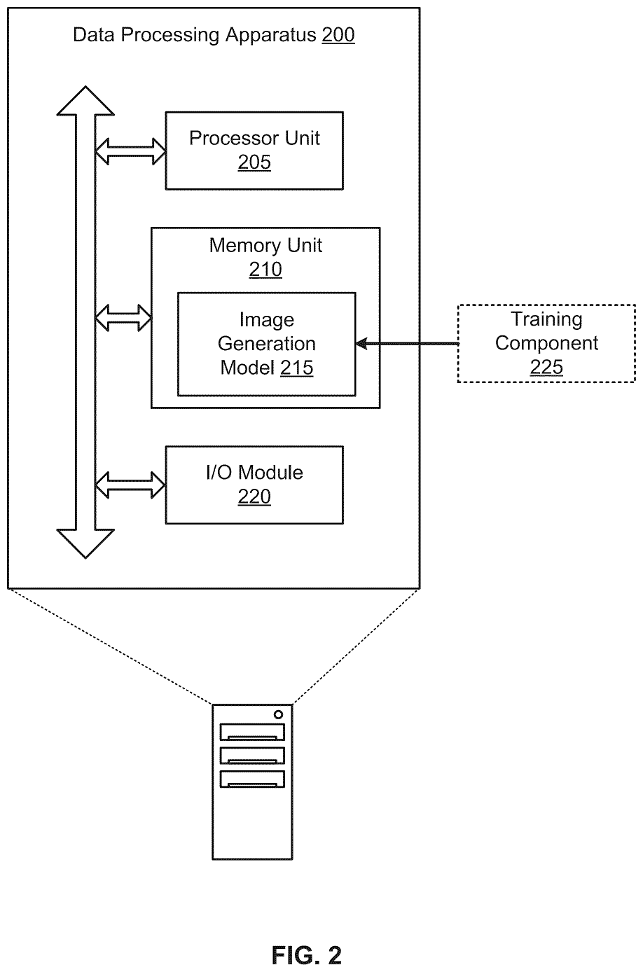

FIG. 2 shows an example of a data processing apparatus 200 according to aspects of the present disclosure. data processing apparatus 200 may include an example of, or aspects of, the guided diffusion model described with reference to FIG. 1 and the U-Net described with reference to FIG. 2. In some embodiments, data processing apparatus 200 includes processor unit 205, memory unit 210, image generation model 215, I/O module 220, and training component 225. Training component 225 updates parameters of the image generation model 215 stored in memory unit 210. In some examples, the training component 225 is located outside the data processing apparatus 200.

Processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

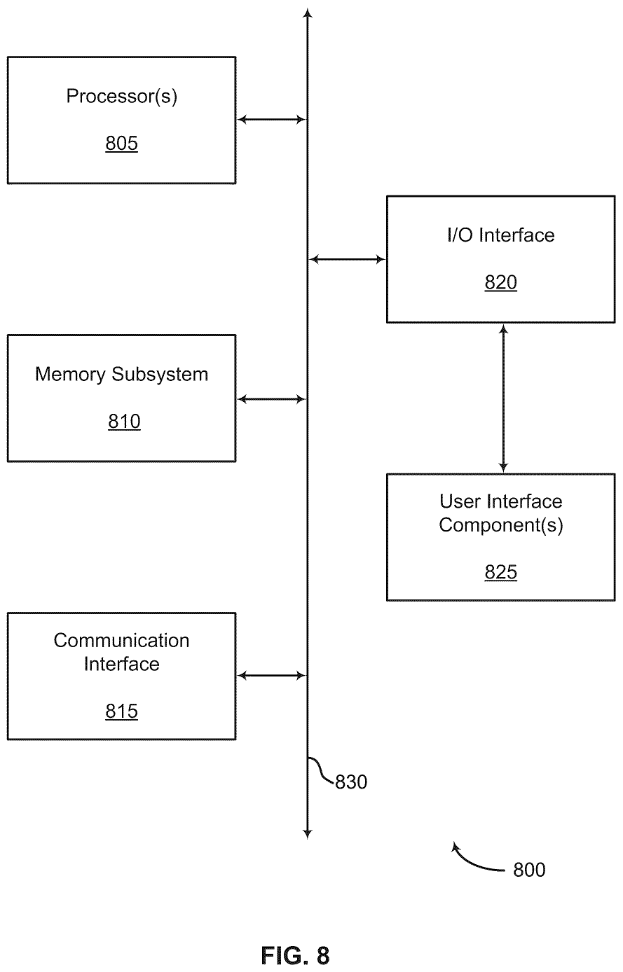

In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some aspects, processor unit 205 includes special purpose components for modem processing, baseband processing, digital signal processing, or transmission processing. According to some aspects, processor unit 205 comprises one or more processors described with reference to FIG. 8.

Memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 205 to perform various functions described herein.

In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state. According to some aspects, memory unit 210 is an example of the memory subsystem 810 described with reference to FIG. 8.

According to some aspects, data processing apparatus 200 uses one or more processors of processor unit 205 to execute instructions stored in memory unit 210 to perform functions described herein. For example, the data processing apparatus 200 may perform a diffusion process based on a second order time trajectory.

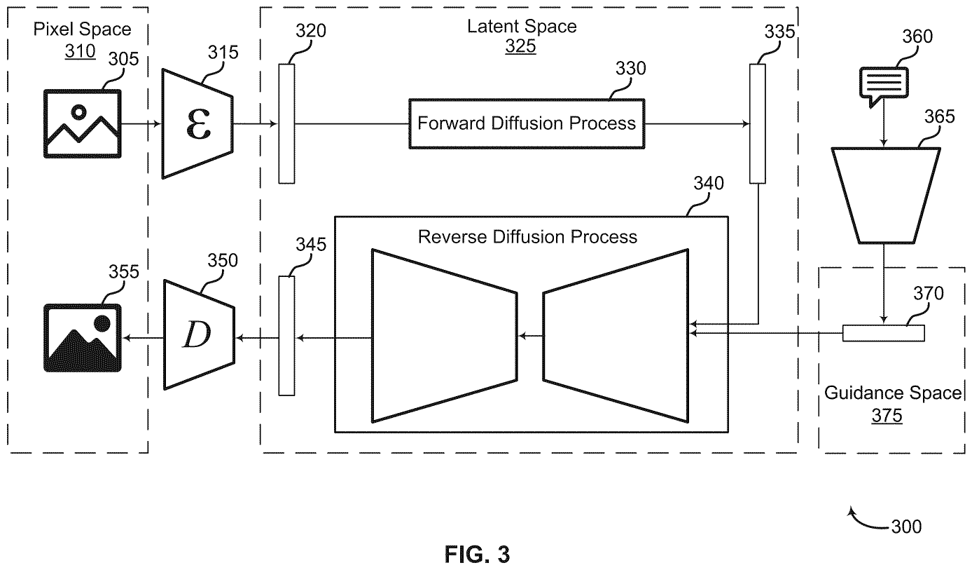

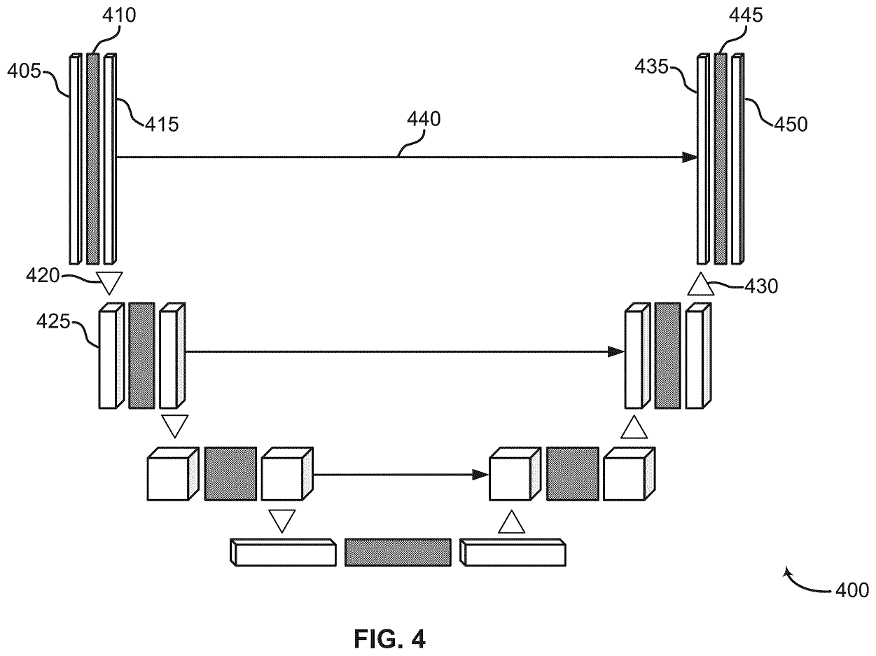

The memory unit 210 may include an image generation model 215 trained to generate synthetic images, where the generation is based on computing, using the image generation model, a denoising vector based on a second order differential equation representing an accelerated denoising trajectory; and generating, using the image generation model, a synthetic image by denoising a noise map based on the denoising vector. For example, after training, the image generation model 215 may perform inferencing operations as described with reference to FIGS. 3 and 4.

In some embodiments, the image generation model 215 is an Artificial neural network (ANN) such as the guided diffusion model described with reference to FIG. 1 and the U-Net described with reference to FIG. 2. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 215 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

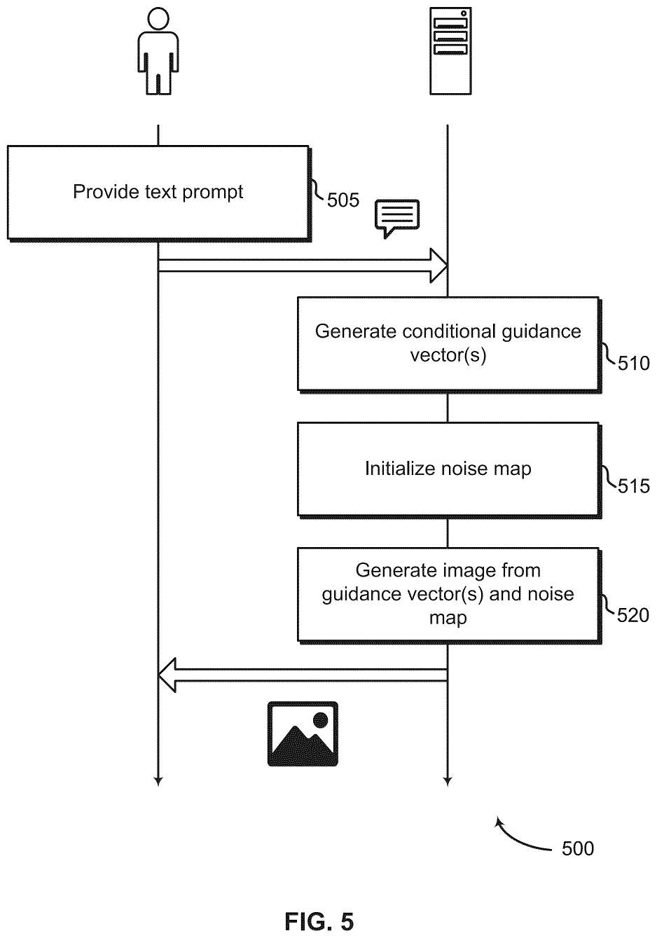

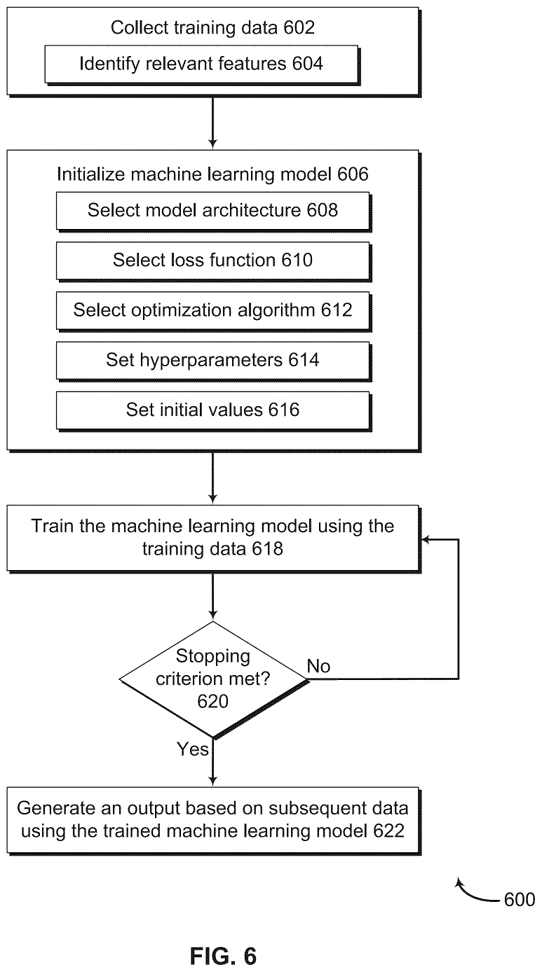

Training component 225 may train the image generation model 215. For example, parameters of the image generation model 215 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 5 and 6). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 215 can be used to make predictions on new, unseen data (i.e., during inference).

I/O module 220 receives inputs from and transmits outputs of the data processing apparatus 200 to other devices or users. For example, I/O module 220 receives inputs for the image generation model 215 and transmits outputs of the image generation model 215. According to some aspects, I/O module 220 is an example of the I/O interface 820 described with reference to FIG. 8.

According to some aspects, image generation model 215 computes, using an image generation model 215, a denoising vector based on a second order differential equation representing an accelerated denoising trajectory. In some examples, image generation model 215 generates a synthetic image by denoising the noise map based on the denoising vector. In some examples, image generation model 215 iteratively updates the denoising vector. In some examples, image generation model 215 iteratively denoises the noise map based on the updated denoising vector. In some examples, image generation model 215 identifies a set of diffusion steps based on a scheduling function, where the denoising vector is updated at each of the set of diffusion steps. The scheduling function may, for example, determine the attenuation parameters described with reference to Equation (2).

In some aspects, the second order differential equation is based on a Nesterov's accelerated gradient descent for the accelerated denoising trajectory. In some aspects, the second order differential equation is based on a collocation method discretization for the accelerated denoising trajectory. In some examples, image generation model 215 computes a score function independent of a momentum variable.

FIG. 3 shows an example of a guided latent diffusion model 300 according to aspects of the present disclosure. The guided latent diffusion model 300 depicted in FIG. 3 is an example of, or includes aspects of, the image generation model described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340.

According to some aspects, text encoder 365 obtains an input prompt describing an image element. In some examples, text encoder 365 encodes the input prompt to obtain guidance information representing the image element, where the denoising vector computed by the image generation model is computed based on the guidance information and the synthetic image depicts the image element. Embodiments of text encoder include, for example, the CLIP pretrained text encoder.

FIG. 4 shows an example of a U-Net 400 according to aspects of the present disclosure. The U-Net 400 depicted in FIG. 4 is an example of, or includes aspects of, the architecture used within the reverse diffusion process described with reference to FIG. 3 and Equation 2.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 features have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having the same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415.

FIG. 5 shows an example of a method 500 for conditional image generation according to aspects of the present disclosure. In some examples, method 500 describes an operation of the image generation model 215 described with reference to FIG. 2 such as an application of the guided diffusion model 300 described with reference to FIG. 3. In some examples, these operations are performed by a system including a processor executing a set of codes to control functional elements of an apparatus such as the image generation model described in FIG. 3.

Additionally or alternatively, steps of the method 500 may be performed using special-purpose hardware. Generally, these operations are performed according to the methods and processes described in accordance with aspects of the present disclosure. In some cases, the operations described herein are composed of various substeps or are performed in conjunction with other operations.

At operation 505, a user provides a text prompt describing content to be included in a generated image. For example, a user may provide the prompt “a person playing with a cat”. In some examples, guidance can be provided in a form other than text, such as via an image, a sketch, or a layout.

At operation 510, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 515, a noise map is initialized that includes random noise. The noise map may be in a pixel space or a latent space. By initializing an image with random noise, different variations of an image including the content described by the conditional guidance can be generated.

At operation 520, the system generates an image based on the noise map and the conditional guidance vector. For example, the image may be generated using a reverse diffusion process as described with reference to Equation (2).

FIG. 6 is a flow diagram depicting an algorithm as a step-by-step procedure 600 in an example implementation of operations performable for training a machine-learning model. In some embodiments, the procedure 600 describes an operation of the training component 225 described for configuring the image generation model 215 as described with reference to FIG. 2. The procedure 600 provides one or more examples of generating training data, use of the training data to train a machine-learning model, and use of the trained machine-learning model to perform a task.

To begin in this example, a machine-learning system collects training data (block 602) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 604) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 606). Initialization of the machine-learning model includes selecting a model architecture (block 608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 610). The loss function is utilized to measure a difference between an output of the machine-learning model (i.e., predictions) and target values (e.g., as expressed by the training data) to be used to train the machine-learning model. Additionally, an optimization algorithm is selected (612) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 614) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 618) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 620), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 620), the procedure 600 continues training of the machine-learning model using the training data (block 618) in this example.

If the stopping criterion is met (“yes” from decision block 620), the trained machine-learning model is then utilized to generate an output based on subsequent data (block 622). The trained machine-learning model, for instance, is trained to perform a task as described above and therefore once trained is configured to perform that task based on subsequent data received as an input and processed by the machine-learning model.

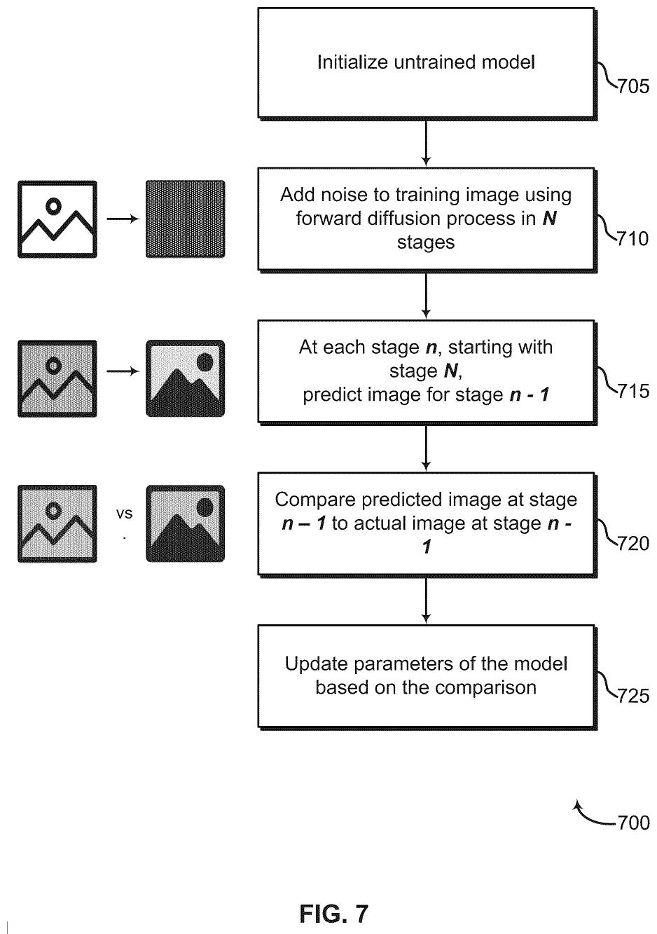

FIG. 7 shows an example of a method 700 for training a diffusion model according to aspects of the present disclosure. In some embodiments, the method 700 describes an operation of the training component 225 described for configuring the image generation model 215 as described with reference to FIG. 2. The method 700 represents an example for training a reverse diffusion process. The reverse diffusion process may be trained using the noise-denoise paradigm, unlike the score approach of Equation 2, however, the inference method described by Equation 2 can still be used despite a noise-denoise-type training. In some examples, these operations are performed by a system including a processor executing a set of codes to control functional elements of an apparatus, such as the guided diffusion model described in FIG. 3.

Additionally or alternatively, certain processes of method 700 may be performed using special-purpose hardware. Generally, these operations are performed according to the methods and processes described in accordance with aspects of the present disclosure. In some cases, the operations described herein are composed of various substeps or are performed in conjunction with other operations.

At operation 705, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 710, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 715, the system at each stage n, starting with stage N, a reverse diffusion process is used to predict the image or image features at stage n-1. For example, the reverse diffusion process can predict the noise that was added by the forward diffusion process, and the predicted noise can be removed from the image to obtain the predicted image. In some cases, an original image is predicted at each stage of the training process.

At operation 720, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 725, the system updates parameters of the model based on the comparison. For example, parameters of a U-Net may be updated using gradient descent. Time-dependent parameters of the Gaussian transitions can also be learned.

FIG. 8 shows an example of a computing device 800 according to aspects of the present disclosure. The example shown includes computing device 800, processor(s) 805, memory subsystem 810, communication interface 815, I/O interface 820, user interface component(s), and channel 830.

In some embodiments, computing device 800 is an example of, or includes aspects of, the data processing apparatus 200 of FIG. 2. In some embodiments, computing device 800 includes one or more processors 805 are configured to execute instructions stored in memory subsystem 810 to obtain a noise map; compute, using an image generation model, a denoising vector based on a second order differential equation representing an accelerated denoising trajectory; and generate, using the image generation model, a synthetic image by denoising the noise map based on the denoising vector.

According to some aspects, computing device 800 includes one or more processors 805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 815 operates at a boundary between communicating entities (such as computing device 800, one or more user devices, a cloud, and one or more databases) and channel 830 and can record and process communications. In some cases, communication interface 815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 820 is controlled by an I/O controller to manage input and output signals for computing device 800. In some cases, I/O interface 820 manages peripherals not integrated into computing device 800. In some cases, I/O interface 820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 820 or via hardware components controlled by the I/O controller.

According to some aspects, user interface component(s) 825 enable a user to interact with computing device 800. In some cases, user interface component(s) 825 include an audio device, such as an external speaker system, an external display device such as a display screen, an input device (e.g., a remote-control device interfaced with a user interface directly or through the I/O controller), or a combination thereof. In some cases, user interface component(s) 825 include a GUI, such as the one described with reference to FIG. 8.

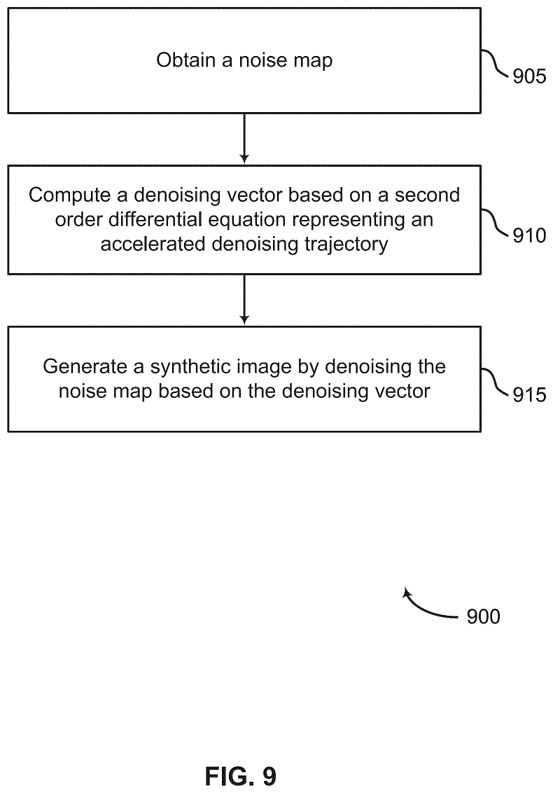

FIG. 9 shows an example of a method 900 for generating a synthetic image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 905, the system obtains a noise map. In some cases, the operations of this step refer to, or may be performed by, a data processing apparatus as described with reference to FIG. 2. The system may, for example, sample from a noise distribution such as a Gaussian distribution. The noise map may have dimensions corresponding to the width and height dimensions of an image or may have dimensions corresponding to a latent space (e.g., with a large depth dimension).

At operation 910, the system computes, using an image generation model, a denoising vector based on a second order differential equation representing an accelerated denoising trajectory. The system may compute the accelerated denoising trajectory described by Equation 2 above, using a discretized form of the trajectory. The discretization may be a form of Nesterov discretization, collocation method discretization, or by using symplectic integrators.

At operation 915, the system generates, using the image generation model, a synthetic image by denoising the noise map based on the denoising vector. The synthetic image may depict an element from a training distribution, and/or may depict an element from an input guidance such as a text prompt.

Accordingly, the present disclosure includes the following aspects.

A method for data generation is described. One or more aspects of the method include obtaining a noise map; computing, using an image generation model, a denoising vector based on a second order differential equation representing an accelerated denoising trajectory; and generating, using the image generation model, a synthetic image by denoising the noise map based on the denoising vector.

Some examples of the method, apparatus, non-transitory computer readable medium, and system further include iteratively updating the denoising vector. Some examples further include iteratively denoising the noise map based on the updated denoising vector.

Some examples of the method, apparatus, non-transitory computer readable medium, and system further include identifying a plurality of diffusion steps based on a scheduling function, wherein the denoising vector is updated at each of the plurality of diffusion steps. Some examples further include obtaining an input prompt describing an image element. Some examples further include encoding the input prompt to obtain guidance information representing the image element, wherein the denoising vector is computed based on the guidance information and the synthetic image depicts the image element.

In some aspects, the second order differential equation is based on a Nesterov's accelerated gradient descent for the accelerated denoising trajectory. In some aspects, the second order differential equation is based on a collocation method discretization for the accelerated denoising trajectory. Some examples further include computing, using the image generation model, a score function independent of a momentum variable.

An apparatus for data generation is described. One or more aspects of the apparatus include at least one processor; at least one memory storing instructions executable by the at least one processor; and an image generation model comprising parameters stored in the at least one memory and configured to compute a denoising vector based on a second order differential equation representing an accelerated denoising trajectory and to generate a synthetic image by denoising a noise map based on the denoising vector.

In some aspects, the second order differential equation is based on a Nesterov's accelerated gradient descent for the accelerated denoising trajectory. In some aspects, the second order differential equation is based on a collocation method discretization for the accelerated denoising trajectory.

In some aspects, the image generation model comprises a diffusion model. In some aspects, the image generation model is further configured to iteratively update the denoising vector, and to iteratively denoise the noise map based on the updated denoising vector. In some aspects, the image generation model is further configured to identify a plurality of diffusion steps based on a scheduling function, wherein the denoising vector is updated at each of the plurality of diffusion steps.

Some examples of the apparatus, system, and method further include a text encoder configured to encode an input prompt describing an image element to obtain guidance information representing the image element, wherein the denoising vector is computed based on the guidance information and the synthetic image depicts the image element.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a noise map;
computing, using an image generation model, a denoising vector based on an accelerated denoising trajectory, wherein the accelerated denoising trajectory accelerates a denoising rate based on a diffusion timestep; and
generating, using the image generation model, a synthetic image by denoising the noise map based on the denoising vector.

2. The method of claim 1, further comprising:
iteratively updating the denoising vector; and
iteratively denoising the noise map based on the updated denoising vector.

3. The method of claim 2, further comprising:
identifying a plurality of diffusion steps based on a scheduling function, wherein the denoising vector is updated at each of the plurality of diffusion steps.

4. The method of claim 1, further comprising:
obtaining an input prompt describing an image element; and
encoding the input prompt to obtain guidance information representing the image element, wherein the denoising vector is computed based on the guidance information and the synthetic image depicts the image element.

5. The method of claim 1, wherein:
the accelerated denoising trajectory is based on Nesterov's accelerated gradient descent.

6. The method of claim 1, wherein:
the accelerated denoising trajectory is based on a collocation method discretization.

7. The method of claim 1, further comprising:
computing, using the image generation model, a score function independent of a momentum variable.

8. A non-transitory computer readable medium storing code for image processing, the code comprising instructions that, when executed by at least one processor, cause the at least one processor to perform operations comprising:
identifying a diffusion step based on a scheduling function;
computing a denoising vector based on the diffusion step and an accelerated denoising trajectory, wherein the accelerated denoising trajectory accelerates a denoising rate based on a diffusion timestep; and
generating a synthetic image by denoising a noise map based on the denoising vector.

9. The non-transitory computer readable medium of claim 8, the code further comprising instructions executable by the at least one processor to perform operations comprising:
iteratively updating the denoising vector; and
iteratively denoising the noise map based on the updated denoising vector.

10. The non-transitory computer readable medium of claim 8, the code further comprising instructions executable by the at least one processor to perform operations comprising:
obtaining an input prompt describing an image element; and
encoding the input prompt to obtain guidance information representing the image element, wherein the denoising vector is computed based on the guidance information and the synthetic image depicts the image element.

11. The non-transitory computer readable medium of claim 8, wherein:
the accelerated denoising trajectory is based on Nesterov's accelerated gradient descent.

12. The non-transitory computer readable medium of claim 8, wherein:
the accelerated denoising trajectory is based on a collocation method discretization.

13. The non-transitory computer readable medium of claim 8, the code further comprising instructions executable by the at least one processor to perform operations comprising:
computing a score function independent of a momentum variable.

14. An apparatus comprising:
at least one processor;
at least one memory storing instructions executable by the at least one processor; and
an image generation model comprising parameters stored in the at least one memory and configured to compute a denoising vector based on an accelerated denoising trajectory and to generate a synthetic image by denoising a noise map based on the denoising vector, wherein the accelerated denoising trajectory accelerates a denoising rate based on a diffusion timestep.

15. The apparatus of claim 14, wherein:
the image generation model comprises a diffusion model.

16. The apparatus of claim 14, wherein:
the image generation model is further configured to iteratively update the denoising vector, and to iteratively denoise the noise map based on the updated denoising vector.

17. The apparatus of claim 16, wherein:
the image generation model is further configured to identify a plurality of diffusion steps based on a scheduling function, wherein the denoising vector is updated at each of the plurality of diffusion steps.

18. The apparatus of claim 14, further comprising:
a text encoder configured to encode an input prompt describing an image element to obtain guidance information representing the image element, wherein the denoising vector is computed based on the guidance information and the synthetic image depicts the image element.

19. The apparatus of claim 14, wherein:
the accelerated denoising trajectory is based on Nesterov's accelerated gradient descent.

20. The apparatus of claim 14, wherein:
the accelerated denoising trajectory is based on a collocation method discretization.
